(19) United States
(12) Patent Application Publication
(10) Pub. No.: US 2025/0337442 A1
(43) Pub. Date: Oct. 30, 2025

(54) OVER-CURRENT PROTECTION FOR A POWER AMPLIFIER

(71) Applicant: QUALCOMM Incorporated, San Diego, CA (US)

(72) Inventors: Jianguo YAO, Londonderry, NH (US); Marc Gerald DICICCO, Dunstable, MA (US); Scott DAVENPORT, Merrimack, NH (US); Bonhoon KOO, San Diego, CA (US); Antonino SCUDERI, San Diego, CA (US); Md Naimul HASAN, San Diego, CA (US)

(21) Appl. No.: 18/816,747

(22) Filed: Aug. 27, 2024

Related U.S. Application Data
(60) Provisional application No. 63/639,450, filed on Apr. 26, 2024.

(51) Int. Cl. H04B 1/04; H04B 1/40

(52) U.S. Cl. CPC H04B 1/0475; H04B 1/40; H04B 2001/0416

(57) ABSTRACT

Certain aspects of the present disclosure generally relate to electronic circuits and, more particularly, to techniques and apparatus for signal amplification. One example method for signal amplification generally includes detecting an over-current condition associated with an amplifier and adjusting an amplification gain to an adjusted gain level for an input signal based on the over-current condition. The amplification gain may be maintained at the adjusted gain level until occurrence of an amplifier gain event. The method may also include amplifying, via the amplifier, the input signal based on the adjusted amplification gain.

### CROSS-REFERENCE TO RELATED APPLICATION

The present application for patent claims the benefit of priority to U.S. Provisional Patent Appl. No. 63/639,450, filed Apr. 26, 2024, which is hereby incorporated by reference herein in its entirety.

### TECHNICAL FIELD

Certain aspects of the present disclosure generally relate to electronic circuits and, more particularly, to techniques and apparatus for signal amplification.

### BACKGROUND

Wireless communication devices are widely deployed to provide various communication services such as telephony, video, data, messaging, broadcasts, and so on. Such wireless communication devices may transmit and/or receive radio frequency (RF) signals via any of various suitable radio access technologies (RATs) including, but not limited to, 5G New Radio (NR), Long Term Evolution (LTE), Code Division Multiple Access (CDMA), Time Division Multiple Access (TDMA), Wideband CDMA (WCDMA), Global System for Mobility (GSM), Bluetooth, Bluetooth Low Energy (BLE), ZigBee, wireless local area network (WLAN) RATs (e.g., WiFi), and the like.

A wireless communication network may include a number of base stations or access points that can support communication for a number of mobile stations. A mobile station (MS) or access terminal may communicate with a base station (BS) or access point via a downlink and an uplink. The downlink (or forward link) refers to the communication link from the base station or access point to the mobile station or access terminal, and the uplink (or reverse link) refers to the communication link from the mobile station or access terminal to the base station or access point. A base station or access point may transmit data and control information on the downlink to the mobile station or access terminal. The base station or access point may also receive data and control information on the uplink from the mobile station or access terminal. The base station (or access point) and/or mobile station (or access terminal) may include a power amplifier (PA) for signal amplification.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide the advantages described herein.

Certain aspects of the present disclosure are directed towards a method for signal amplification. The method generally includes: detecting an over-current condition associated with an amplifier; adjusting an amplification gain to an adjusted gain level for an input signal based on the over-current condition, wherein the amplification gain is maintained at the adjusted gain level until occurrence of an amplifier gain event; and amplifying, via the amplifier, the input signal based on the adjusted amplification gain.

Certain aspects of the present disclosure are directed towards an apparatus for signal amplification. The apparatus generally includes: an amplifier; an over-current detection circuit coupled to the amplifier and configured to detect an over-current condition associated with the amplifier; and a latch having an input coupled to an output of the over-current detection circuit and configured to adjust an amplification gain to an adjusted amplification gain level for an input signal based on the over-current condition, wherein the amplification gain is maintained at the adjusted amplification gain level until occurrence of an amplifier gain event, wherein the amplifier is configured to amplify the input signal based on the adjusted amplification gain level.

Certain aspects of the present disclosure are directed towards an apparatus for signal amplification. The apparatus generally includes: an amplifier; a gain control circuit coupled to the amplifier; an over-current detection circuit coupled to the amplifier; and a latch having a first input coupled to an output of the over-current detection circuit and a second input configured to receive a control signal indicative of an amplifier gain event, the latch having an output coupled to the gain control circuit.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in which aspects of the present disclosure may be practiced.

FIG. 2 is a block diagram conceptually illustrating a design of an example base station (BS) or access point (AP) and user equipment (UE), in which aspects of the present disclosure may be practiced.

FIG. 3 is a block diagram of an example radio frequency (RF) transceiver, in which aspects of the present disclosure may be practiced.

FIG. 4 is a block diagram of an example amplification control circuit for over-current protection (OCP), in accordance with certain aspects of the present disclosure.

FIG. 5 illustrates an example amplification control circuit for over-current detection and amplification gain control, in accordance with certain aspects of the present disclosure.

FIG. 6 illustrates an amplification control circuit for OCP and over-voltage protection (OVP), in accordance with certain aspects of the present disclosure.

FIG. 7 is a flow diagram illustrating example operations for signal amplification, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure are directed towards techniques and apparatus for performing over-current protection (OCP). For example, an over-current condition associated with an amplifier may be detected, in response to which an amplification gain may be adjusted to an adjusted gain level. The amplification gain may be maintained at the adjusted gain level until occurrence of an amplifier gain event. For example, the amplifier gain event may correspond to a transmission of a new packet resulting in a new gain setting for the amplifier. The amplifier may be used to amplify an input signal based on the adjusted amplification gain. In some aspects, a latch may be used to maintain the adjusted gain level until the amplifier gain event occurs, as described in more detail herein. The techniques described herein allow for OCP with reduced spurs and resultant interference as compared to some other implementations that perform OCP by chopping the amplifier output signal.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Wireless System

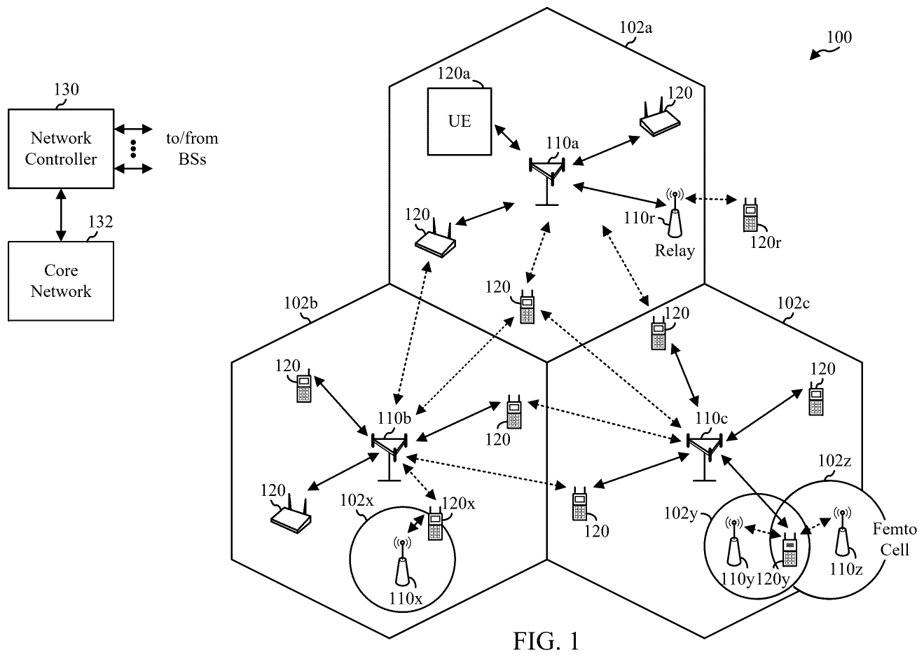

FIG. 1 illustrates an example wireless communications network 100, in which aspects of the present disclosure may be practiced. For example, the wireless communications network 100 may be a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation/Third Generation (2G/3G) network), or a code division multiple access (CDMA) system (e.g., a 2G/3G network), or may be configured for communications according to an IEEE standard such as one or more of the 802.11 standards, etc.

As illustrated in FIG. 1, the wireless communications network 100 may include a number of base stations (BSs) 110a-z (each also individually referred to herein as “BS 110” or collectively as “BSs 110”) and other network entities. A BS may also be referred to as an access point (AP), an evolved Node B (eNodeB or eNB), a next generation Node B (gNodeB or gNB), or some other terminology.

A BS 110 may provide communication coverage for a particular geographic area, sometimes referred to as a “cell,” which may be stationary or may move according to the location of a mobile BS. In some examples, the BSs 110 may be interconnected to one another and/or to one or more other BSs or network nodes (not shown) in wireless communications network 100 through various types of backhaul interfaces (e.g., a direct physical connection, a wireless connection, a virtual network, or the like) using any suitable transport network. In the example shown in FIG. 1, the BSs 110a, 110b, and 110c may be macro BSs for the macro cells 102a, 102b, and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with one or more user equipments (UEs) 120a-y (each also individually referred to herein as “UE 120” or collectively as “UEs 120”) in the wireless communications network 100. A UE may be fixed or mobile and may also be referred to as a user terminal (UT), a mobile station (MS), an access terminal, a station (STA), a client, a wireless device, a mobile device, or some other terminology. A user terminal may be a wireless device, such as a cellular phone, a smartphone, a personal digital assistant (PDA), a handheld device, a wearable device, a wireless modem, a laptop computer, a tablet, a personal computer, etc.

The BSs 110 are considered transmitting entities for the downlink and receiving entities for the uplink. The UEs 120 are considered transmitting entities for the uplink and receiving entities for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink. Nᵤₚ UEs may be selected for simultaneous transmission on the uplink, N_{dn} UEs may be selected for simultaneous transmission on the downlink. Nᵤₚ may or may not be equal to N_{dn}, and Nᵤₚ and N_{dn} may be static values or can change for each scheduling interval. Beam-steering or some other spatial processing technique may be used at the BSs 110 and/or UEs 120.

The UEs 120 (e.g., 120x, 120y, etc.) may be dispersed throughout the wireless communications network 100, and each UE 120 may be stationary or mobile. The wireless communications network 100 may also include relay stations (e.g., relay station 110r), also referred to as relays or the like, that receive a transmission of data and/or other information from an upstream station (e.g., a BS 110a or a UE 120r) and send a transmission of the data and/or other information to a downstream station (e.g., a UE 120 or a BS 110), or that relays transmissions between UEs 120, to facilitate communication between devices.

The BSs 110 may communicate with one or more UEs 120 at any given moment on the downlink and uplink. The downlink (i.e., forward link) is the communication link from the BSs 110 to the UEs 120, and the uplink (i.e., reverse link) is the communication link from the UEs 120 to the BSs 110. A UE 120 may also communicate peer-to-peer with another UE 120.

The wireless communications network 100 may use multiple transmit and multiple receive antennas for data transmission on the downlink and uplink. BSs 110 may be equipped with a number Nₐₚ of antennas to achieve transmit diversity for downlink transmissions and/or receive diversity for uplink transmissions. A set Nᵤ of UEs 120 may receive downlink transmissions and transmit uplink transmissions. Each UE 120 may transmit user-specific data to and/or receive user-specific data from the BSs 110. In general, each UE 120 may be equipped with one or multiple antennas. The Nᵤ UEs 120 can have the same or different numbers of antennas.

The wireless communications network 100 may be a time division duplex (TDD) system or a frequency division duplex (FDD) system. For a TDD system, the downlink and uplink share the same frequency band. For an FDD system, the downlink and uplink use different frequency bands. The wireless communications network 100 may also utilize a single carrier or multiple carriers for transmission. Each UE 120 may be equipped with a single antenna (e.g., to keep costs down) or multiple antennas (e.g., where the additional cost can be supported).

A network controller 130 (also sometimes referred to as a “system controller”) may be in communication with a set of BSs 110 and provide coordination and control for these BSs 110 (e.g., via a backhaul). In certain cases (e.g., in a 5G NR system), the network controller 130 may include a centralized unit (CU) and/or a distributed unit (DU). In certain aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc. The UE 120 and/or 110 may be implemented with one or more amplifiers with over-current protection (OCP), as described in more detail herein.

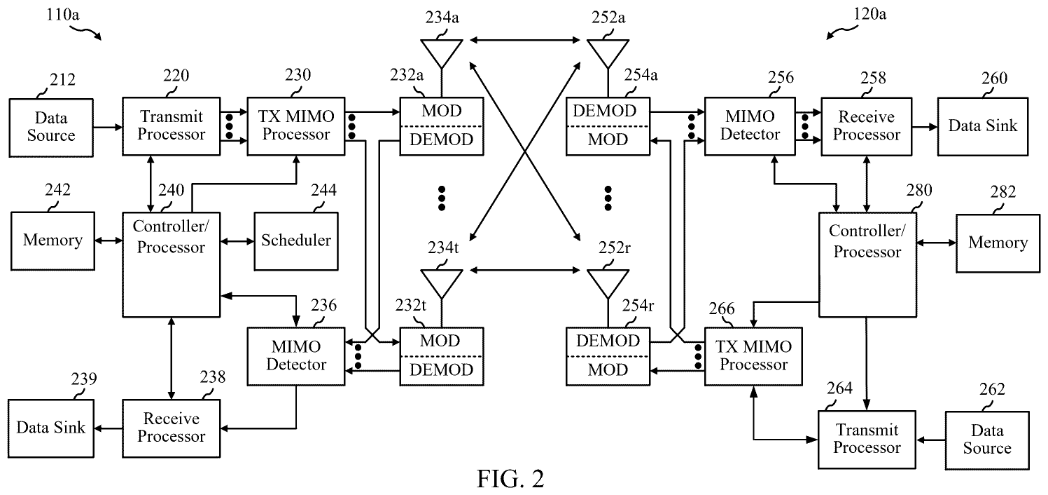

FIG. 2 illustrates example components of BS 110a and UE 120a (e.g., from the wireless communications network 100 of FIG. 1), in which aspects of the present disclosure may be implemented.

On the downlink, at the BS 110a, a transmit processor 220 may receive data from a data source 212, control information from a controller/processor 240, and/or possibly other data (e.g., from a scheduler 244). The various types of data may be sent on different transport channels. For example, the control information may be designated for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), etc. The data may be designated for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a PDSCH, a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS).

A transmit (TX) multiple-input, multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for orthogonal frequency division multiplexing (OFDM), etc.) to obtain an output sample stream. Each of the transceivers 232a-232t may further process (e.g., convert to analog, amplify, filter, and upconvert) the output sample stream to obtain a downlink signal. Downlink signals from the transceivers 232a-232t may be transmitted via the antennas 234a-234t, respectively.

At the UE 120a, the antennas 252a-252r may receive the downlink signals from the BS 110a and may provide received signals to the transceivers 254a-254r, respectively. The transceivers 254a-254r may condition (e.g., filter, amplify, downconvert, and digitize) a respective received signal to obtain input samples. Each demodulator (DEMOD) in the transceivers 232a-232t may further process the input samples (e.g., for OFDM, etc.) to obtain received symbols. A MIMO detector 256 may obtain received symbols from the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH)) from the controller/processor 280. The transmit processor 264 may also generate reference symbols for a reference signal (e.g., the sounding reference signal (SRS)). The symbols from the transmit processor 264 may be precoded by a TX MIMO processor 266 if applicable, further processed by the modulators (MODs) in transceivers 254a-254r (e.g., for single-carrier frequency division multiplexing (SC-FDM), etc.), and transmitted to the BS 110a. At the BS 110a, the uplink signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. The memories 242 and 282 may also interface with the controllers/processors 240 and 280, respectively. A scheduler 244 may schedule UEs for data transmission on the downlink and/or uplink. The UE 120 and/or 110 transceivers 232a-232t and/or transceivers 254a-254r may be implemented with one or more amplifiers with over-current protection (OCP), as described in more detail herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The system bandwidth may also be partitioned into subbands. For example, a subband may cover multiple resource blocks (RBs).

### Example RF Transceiver

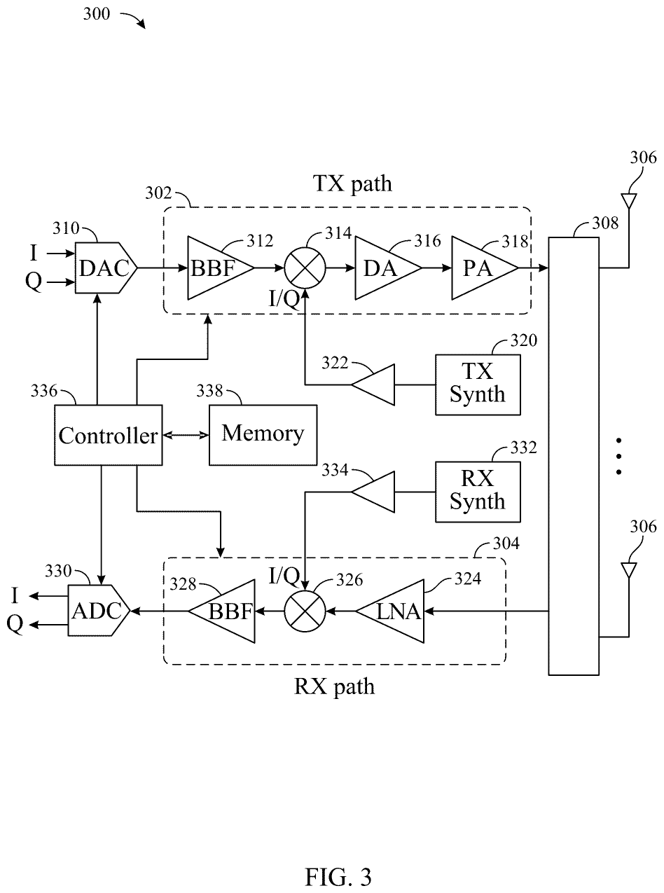

FIG. 3 is a block diagram of an example radio frequency (RF) transceiver circuit 300, in accordance with certain aspects of the present disclosure. The RF transceiver circuit 300 includes at least one transmit (TX) path 302 (also known as a “transmit chain”) for transmitting signals via one or more antennas 306 and at least one receive (RX) path 304 (also known as a “receive chain”) for receiving signals via the antennas 306. When the TX path 302 and the RX path 304 share an antenna 306, the paths may be connected with the antenna via an interface 308, which may include any of various suitable RF devices, such as a switch, a duplexer, a diplexer, a multiplexer, and the like.

Receiving in-phase (I) and/or quadrature (Q) baseband analog signals from a digital-to-analog converter (DAC) 310, the TX path 302 may include a baseband filter (BBF) 312, a mixer 314, a driver amplifier (DA) 316, and a power amplifier (PA) 318. The BBF 312, the mixer 314, the DA 316, and the PA 318 may be included in a radio frequency integrated circuit (RFIC). For certain aspects, the PA 318 may be external to the RFIC.

The BBF 312 filters the baseband signals received from the DAC 310, and the mixer 314 mixes the filtered baseband signals with a transmit local oscillator (LO) signal to convert the baseband signal of interest to a different frequency (e.g., upconvert from baseband to a radio frequency). This frequency-conversion process produces the sum and difference frequencies between the LO frequency and the frequencies of the baseband signal of interest. The sum and difference frequencies are referred to as the “beat frequencies.” The beat frequencies are typically in the RF range, such that the signals output by the mixer 314 are typically RF signals, which may be amplified by the DA 316 and/or by the PA 318 before transmission by the antenna(s) 306. While one mixer 314 is illustrated, several mixers may be used to upconvert the filtered baseband signals to one or more intermediate frequencies and to thereafter upconvert the intermediate frequency (IF) signals to a frequency for transmission. In some aspects, the DA316 and/or PA 318 may be implemented with OCP, as described in more detail herein.

The RX path 304 may include a low noise amplifier (LNA) 324, a mixer 326, and a baseband filter (BBF) 328. The LNA 324, the mixer 326, and the BBF 328 may be included in one or more RFICs, which may or may not be the same RFIC that includes the TX path components. RF signals received via the antenna(s) 306 may be amplified by the LNA 324, and the mixer 326 mixes the amplified RF signals with a receive local oscillator (LO) signal to convert the RF signal of interest to a different baseband frequency (e.g., downconvert). The baseband signals output by the mixer 326 may be filtered by the BBF 328 before being converted by an analog-to-digital converter (ADC) 330 to digital I and/or Q signals for digital signal processing.

Certain transceivers may employ frequency synthesizers with a variable-frequency oscillator (e.g., a voltage-controlled oscillator (VCO) or a digitally controlled oscillator (DCO)) to generate a stable, tunable LO with a particular tuning range. Thus, the transmit LO may be produced by a TX frequency synthesizer 320, which may be buffered or amplified by amplifier 322 before being mixed with the baseband signals in the mixer 314. Similarly, the receive LO may be produced by an RX frequency synthesizer 332, which may be buffered or amplified by amplifier 334 before being mixed with the RF signals in the mixer 326. For certain aspects, a single frequency synthesizer may be used for both the TX path 302 and the RX path 304. In certain aspects, the TX frequency synthesizer 320 and/or RX frequency synthesizer 332 may include a frequency multiplier, such as a frequency doubler, that is driven by an oscillator (e.g., a VCO) in the frequency synthesizer.

A controller 336 (e.g., controller/processor 280 in FIG. 2) may direct the operation of the RF transceiver circuit 300A, such as transmitting signals via the TX path 302 and/or receiving signals via the RX path 304. The controller 336 may be a processor, a digital signal processor (DSP), an application-specific integrated circuit (ASIC), a field-programmable gate array (FPGA) or other programmable logic device (PLD), discrete gate or transistor logic, discrete hardware components, or any combination thereof. A memory 338 (e.g., memory 282 in FIG. 2) may store data and/or program codes for operating the RF transceiver circuit 300. The controller 336 and/or the memory 338 may include control logic (e.g., complementary metal-oxide-semiconductor (CMOS) logic).

While FIGS. 1-3 provide wireless communications as an example application in which certain aspects of the present disclosure may be implemented to facilitate understanding, certain aspects described herein may be used for any of various other suitable systems.

### Example Techniques for Over-Current Protection

Certain aspects of the present disclosure are directed towards techniques for over-current protection (OCP). Some OCP techniques result in the chopping of the power amplifier (PA) output signal, creating spurs in the radio frequency (RF) band. While OCP with chopping maintains a level of RF output power during the OCP and provides real-time action (e.g., the PA returns to normal operation as soon as the over-current condition is over), the generated spurs can cause interference issues. Certain aspects of the present disclosure are directed towards techniques for OCP that cause fewer spurs than other implementations that involve PA output signal chopping.

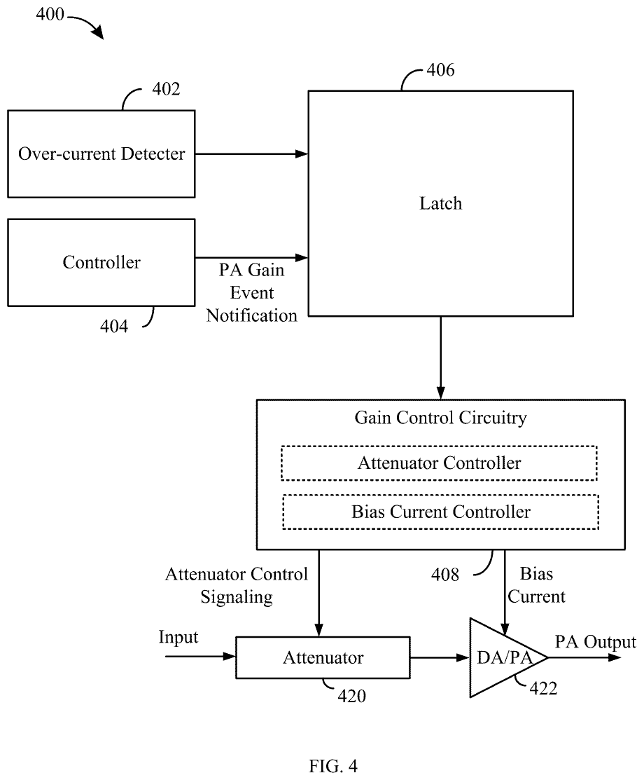

FIG. 4 is a block diagram of an example amplification control circuit 400 for OCP, in accordance with certain aspects of the present disclosure. As shown, an over-current detector 402 (e.g., also referred to herein as an “over-current detection circuit”) may detect an over-current condition for a PA. For example, the detector 402 may indicate that an over-current condition has occurred if the current draw from a battery by the PA (e.g., PA 318 of FIG. 3) and/or drive amplifier (DA) (e.g., DA 316 of FIG. 3) is greater than a threshold. The over-current indication from the detector 402 may be provided to a latch 406. The latch 406 may control a gain control circuit 408 to reduce the amplification gain for an input signal until a subsequent gain event occurs as indicated by a controller 404 (e.g., a modem). Once over-current protection is triggered by reducing the amplification gain based on the over-current indication from the detector 402, the reduced gain may remain in effect (e.g., may be maintained) until a gain event occurs. The gain event may be associated with processing a new packet for transmission, for example, and may involve adjusting the amplification gain for processing the new packet. In this manner, an open-loop over-current protection scheme may be implemented to reduce spurs that cause interference (e.g., due to increased adjacent channel leakage ratio (ACLR)) compared to some other implementations.

Amplification gain may be adjusted in any suitable manner. For example, the amplification gain may be reduced by increasing the attenuation applied to an input signal to be amplified via the PA using an attenuator controller 460. The attenuation may be increased by configuring the attenuator 420 (e.g., configuring one or more switches of the attenuator 420 to adjust an impedance associated with the attenuator 420) coupled to an input of an amplifier 422 (e.g., PA and/or DA) using attenuator control signaling. In some aspects, one or more bias currents to the PA (and/or DA) may be controlled via a bias current controller 462 to adjust the PA (and/or DA) gain, as described in more detail herein.

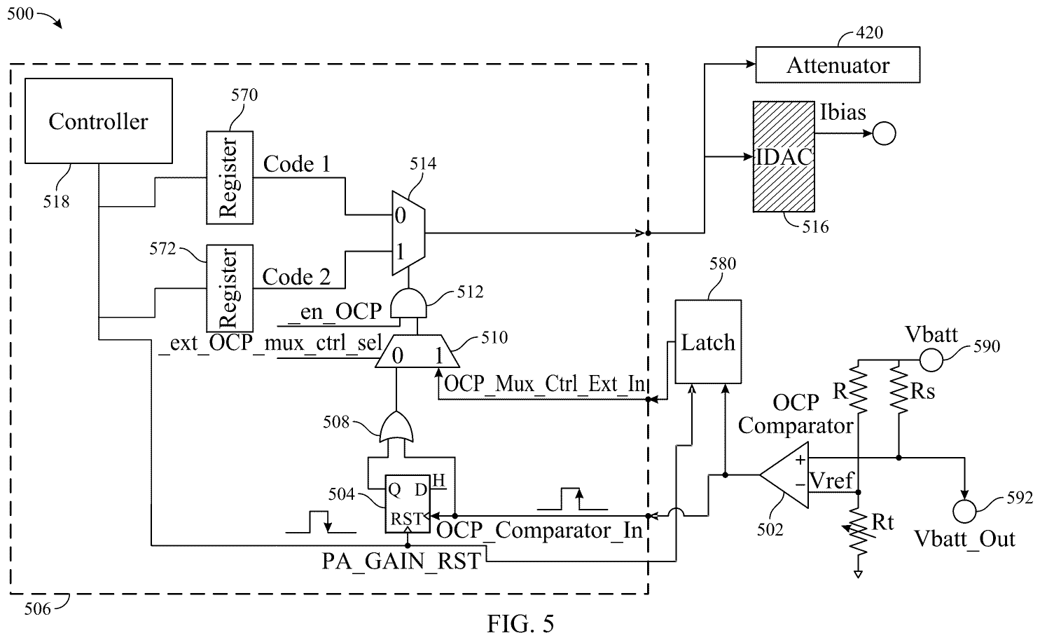

FIG. 5 illustrates an example of an amplification control circuit 500 for over-current detection and amplification gain control, in accordance with certain aspects of the present disclosure. As shown, a sense resistive element (labeled “Rs”) may be used to sense a current drawn via a supply input 592 (labeled “Vbatt_Out”) of a PA from a battery node 590 providing a battery voltage (labeled “Vbatt”). A voltage at the supply input 592 representing the sensed current may be provided to an input of a comparator 502 (e.g., OCP comparator) and compared to a reference voltage (Vref) as shown. It should be appreciated that the current sensing circuitry described illustrates one example of a current sensor and other implementations are possible. Vref may be adjusted using a tunable voltage divider circuit (e.g., implemented via a resistive element labeled “R” and a tunable resistive element labeled “Rt”), as shown. In other words, Vref may track Vbatt based on the set resistance of the tunable resistive element Rt. If the sensed current increases above a threshold current represented by Vref, an OCP comparator input (OCP_comparator_in) signal generated by the comparator 502 transitions to logic high, as shown. The OCP_comparator_in signal may be provided to a clock input of a flip-flop 504 (e.g., delay (D) flip-flop) and to an input of a logical OR gate 508. The output (Q) of the flip-flop 504 may be coupled to another input of the OR gate 508. The flip-flop 504 and OR gate 508 may form a latch such as the latch 406 of FIG. 4. As shown, a controller 518 may provide a PA gain reset (PA_GAIN_RST) signal to a reset input of the flip-flop 504. The controller 518 may be implemented using a mobile industry processor interface (MIPI) core and register controller. The PA_GAIN_RST may be a periodic signal indicating a PA gain event, as described herein. The PA_GAIN_RST signal may also be a dynamic or variable signal that changes in response to a modem signal.

The flip-flop 504 and OR gate 508 may be part of a digital circuit 506. A similar latch 580 may be implemented external to the digital circuit 506 as a backup circuit. The latch 580 may generate an external OCP control input (labeled “OCP_Mux_Ctrl_Ext_In”) signal which may be similar to the signal generated at the output of the OR gate 508 and used as an external backup. The OCP_Mux_Ctrl_Ext_In signal from the latch 580 and the output signal from the OR gate 508 may be provided to respective inputs of a multiplexer 510. The multiplexer 510 may receive an external multiplexer select (labeled “ext_OCP_mux_ctrl_sel”) signal at a select input. Based on the ext_OCP_mux_ctrl_sel signal, the multiplexer may either provide the output signal of the OR gate 508 or the OCP_Mux_Ctrl_Ext_In signal to an input of a logical AND gate 512.

The output signal of the multiplexer 510 may be provided to the input of the AND gate 512, where another input of the AND gate 512 receives an enable OCP (labeled “en_OCP”) signal. The AND gate may be used to enable or disable OCP. For example, the output of the AND gate 512 may provide a logic low signal to a control input of a multiplexer 514 when the en_OCP signal is logic low, effectively disabling OCP. The output of the AND gate may provide the output signal of multiplexer 510 to the control input of the multiplexer 514 when the en_OCP signal is logic high, enabling OCP.

The output signal of the AND gate 512 may be used to control the multiplexer 514. The multiplexer 514 may receive, as inputs, separate (e.g., different) codes (labeled “code 1” and “code 2”) for adjusting the amplification gain as described herein. The separate codes may be stored in respective registers 570, 572 and used to control the bias current for the PA (or DA) (e.g., PA 422 of FIG. 4) or control the attenuator (e.g., attenuator 420), as described herein. For example, the multiplexer 514 may receive code 1 and code 2 that may be stored in respective registers 570, 572. The registers 570, 572 may be controlled by the controller 518, which may also provide the PA_GAIN_RST signal (derived from a modem control signal in some implementations) as described herein. During normal operation, the multiplexer 514 may provide code 1 to a current digital-to-analog converter (IDAC) 516 to generate a bias current (Ibias) for the PA (and/or DA). When OCP is triggered by an output signal of the AND gate 512, the multiplexer 514 provides code 2 to the IDAC 516, reducing the bias current of the PA (and/or DA).

A similar technique may be used for controlling the attenuator 420. For example, a first attenuator control code (code 1) may be provided to the attenuator 420 by the multiplexer 514 during normal operations, and a second attenuator control code (code 2) may be provided to the attenuator 420 by the multiplexer 514 once an over-current condition is triggered. The second attenuator control code may control switches of the attenuator 420 (e.g., via a control input of the attenuator) to increase the attenuation of the input signal provided to the PA.

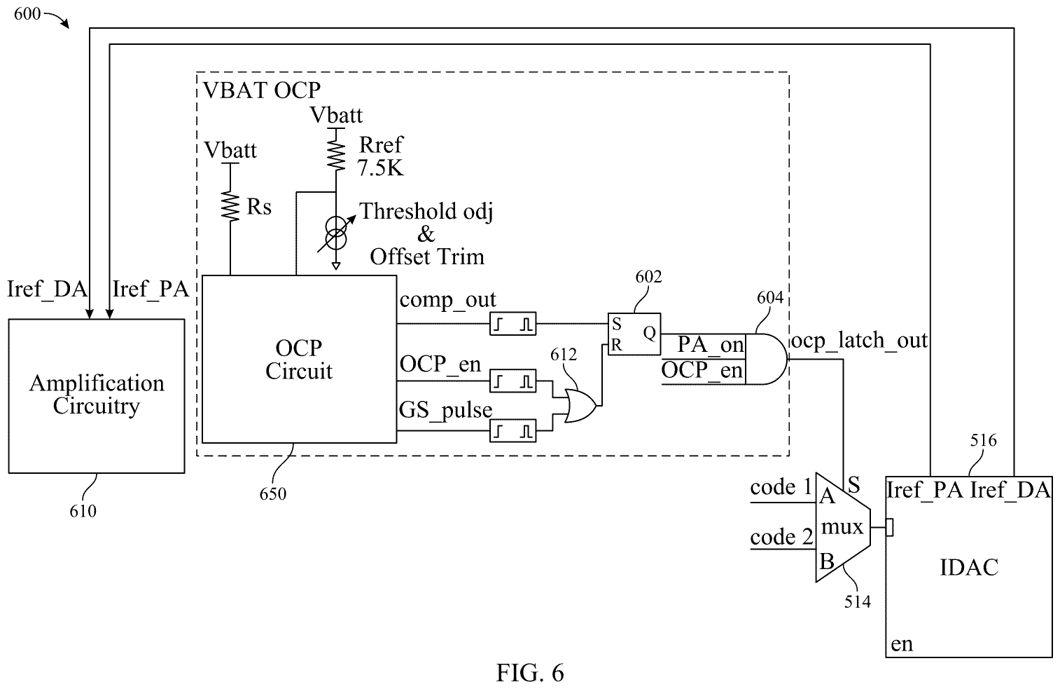

FIG. 6 illustrates an amplification control circuit 600 for OCP and over-voltage protection (OVP), in accordance with certain aspects of the present disclosure. As shown, an OCP circuit 650 may provide a comparator output (comp_out) signal to a set input of a set-reset (SR) flip-flop 602. The comp_out signal may correspond to the output signal of the AND gate 508 and indicate whether to trigger OCP. An OCP enable (OCP_en) signal and gain state (GS) change pulse (GS_pulse) signal (e.g., corresponding to the PA_GAIN_RST signal of FIG. 5) may be provided to inputs of a logical OR gate 612 as shown, where an output of the OR gate is coupled to a reset input of the SR flip-flop 602. The output (Q) of the SR flip-flop 602 may be provided to an input of an AND gate 604, where other inputs of the AND gate 604 receive a PA enable (PA_on) signal and the OCP_en signal, as shown. The output (OCP_latch_out) of the AND gate 604 is used to control the multiplexer 514 receiving the different gain control codes (e.g., corresponding to code 1 and code 2 described with respect to FIG. 5) described herein. For example, the multiplexer 514 may receive code 1 for normal operations and code 2 for OCP, one of which may be provided to the IDAC 516, as described. In other words, when the PA_on signal is logic high and the OCP_en signal is logic high, code 2 may be provided to the IDAC 516 until the GS_pulse signal resets the SR flip-flop 602 in response to a gain event. The IDAC 516 may generate one or more reference currents (e.g., labeled “Iref DA” and “Iref PA”) provided to at least one bias current input of the amplification circuitry 610 (e.g., the DA and/or the PA), as shown. For example, the Iref DA current may be used to bias the DA 316, and the Iref PA may be used to bias the PA 318.

Certain aspects provide techniques for OCP that include swapping an amplification gain code to mitigate a detected over-current condition. As described, the over-current condition may remain in effect until a gain event occurs. For example, a controller may produce a pulse every time a gain state register is written. Swapping the amplification gain code may result in a lowered but stable PA output power since the PA output signal may not be chopped. The over-current condition may be maintained until the beginning of the next PA transmission cycle when the gain state register is written.

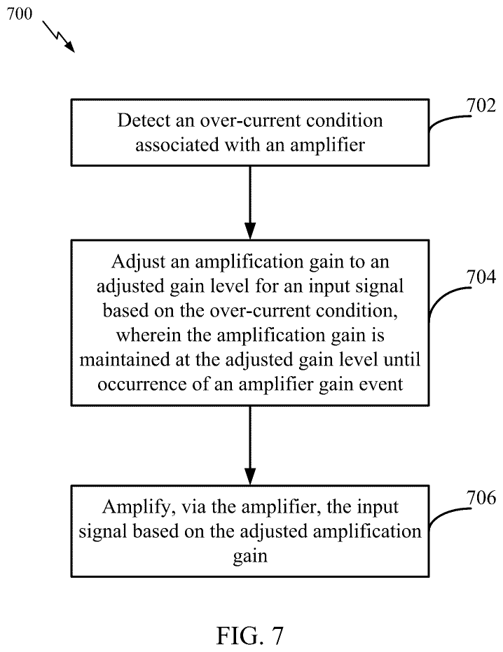

FIG. 7 is a flow diagram illustrating example operations 700 for signal amplification, in accordance with certain aspects of the present disclosure. The operations 700 may be performed, for example, by an amplification control circuit, such as the amplification control circuit 500 of FIG. 5 or amplification control circuit 600 of FIG. 6.

At block 702, the amplification control circuit may detect an over-current condition associated with an amplifier (e.g., DA 316 and/or PA 318). At block 704, the amplification control circuit may adjust an amplification gain to an adjusted gain level for an input signal (e.g., an overall signal amplification gain) based on the over-current condition. The amplification gain may be maintained at the adjusted gain level until occurrence of an amplifier gain event. In some aspects, the amplifier control circuit may receive (e.g., at an input of a latch 406) an amplifier gain event signal indicating the occurrence of the amplifier gain event. The amplifier gain event signal may be a periodic signal. The amplifier gain event may be associated with processing of a new packet for transmission, for example. In some aspects, adjusting the amplification gain may include adjusting a level of attenuation associated with an attenuator (e.g., attenuator 420 of FIG. 4) coupled to an input of the amplifier. In some aspects, adjusting the amplification gain may include adjusting a bias current for the amplifier.

At block 706, the amplification control circuit may amplify, via the amplifier, the input signal based on the adjusted amplification gain.

### EXAMPLE ASPECTS

In addition to the various aspects described above, specific combinations of aspects are within the scope of the present disclosure, some of which are detailed below:

Aspect 1: A method for signal amplification, comprising: detecting an over-current condition associated with an amplifier; adjusting an amplification gain to an adjusted gain level for an input signal based on the over-current condition, wherein the amplification gain is maintained at the adjusted gain level until occurrence of an amplifier gain event; and amplifying, via the amplifier, the input signal based on the adjusted amplification gain.

Aspect 2: The method of Aspect 1, further comprising receiving an amplifier gain event signal indicating the occurrence of the amplifier gain event.

Aspect 3: The method of Aspect 2, wherein the amplifier gain event signal is a periodic signal.

Aspect 4: The method according to any of Aspects 1-3, wherein the amplifier gain event is associated with processing of a new packet for transmission.

Aspect 5: The method according to any of Aspects 1-4, wherein adjusting the amplification gain comprises adjusting a level of attenuation associated with an attenuator coupled to an input of the amplifier.

Aspect 6: The method according to any of Aspects 1-5, wherein adjusting the amplification gain comprises adjusting a bias current for the amplifier.

Aspect 7: An apparatus for signal amplification, comprising: an amplifier; an over-current detection circuit coupled to the amplifier and configured to detect an over-current condition associated with the amplifier; and a latch having an input coupled to an output of the over-current detection circuit and configured to adjust an amplification gain to an adjusted amplification gain level for an input signal based on the over-current condition, wherein the amplification gain is maintained at the adjusted amplification gain level until occurrence of an amplifier gain event, wherein the amplifier is configured to amplify the input signal based on the adjusted amplification gain level.

Aspect 8: The apparatus of Aspect 7, further comprising a multiplexer configured to receive a first amplification gain code and a second amplification gain code, wherein an output of the latch is coupled to a select input of the multiplexer, and wherein an output of the multiplexer is coupled to: a current digital-to-analog converter (IDAC) having an output coupled to a bias current input of the amplifier; or a control input of an attenuator coupled to an input of the amplifier.

Aspect 9: The apparatus of Aspect 7 or 8, wherein the latch is configured to receive an amplifier gain event signal indicating the occurrence of the amplifier gain event.

Aspect 10: The apparatus of Aspect 9, wherein the amplifier gain event signal is a periodic signal.

Aspect 11: The apparatus according to any of Aspects 7-10, wherein the amplifier gain event is associated with processing of a new packet for transmission.

Aspect 12: The apparatus according to any of Aspects 7-11, further comprising an attenuator coupled to an input of the amplifier, wherein, to adjust the amplification gain, the latch is configured to adjust a level of attenuation associated with the attenuator.

Aspect 13: The apparatus according to any of Aspects 7-12, wherein, to adjust the amplification gain, the latch is configured to adjust a bias current for the amplifier.

Aspect 14: An apparatus for signal amplification, comprising: an amplifier; a gain control circuit coupled to the amplifier; an over-current detection circuit coupled to the amplifier; and a latch having a first input coupled to an output of the over-current detection circuit and a second input configured to receive a control signal indicative of an amplifier gain event, the latch having an output coupled to the gain control circuit.

Aspect 15: The apparatus of Aspect 14, wherein the gain control circuit comprises a multiplexer configured to receive a first amplification gain code and a second amplification gain code, wherein an output of the latch is coupled to a select input of the multiplexer, and wherein an output of the multiplexer is coupled to: a current digital-to-analog converter (IDAC) having an output coupled to a bias current input of the amplifier; or a control input of an attenuator coupled to an input of the amplifier.

Aspect 16: The apparatus of Aspect 14 or 15, wherein the control signal is a periodic signal.

Aspect 17: The apparatus according to any of Aspects 14-16, wherein the amplifier gain event is associated with processing of a new packet for transmission.

Aspect 18: The apparatus according to any of Aspects 14-17, further comprising an attenuator coupled to an input of the amplifier, wherein the gain control circuit is configured to adjust a level of attenuation associated with the attenuator.

Aspect 19: The apparatus according to any of Aspects 14-18, wherein the gain control circuit is configured to adjust a bias current for the amplifier.

Aspect 20: The apparatus according to any of Aspects 14-19, wherein the latch comprises: a flip-flop having a clock input forming the first input of the latch and a reset input forming the second input of the latch; and an OR gate having a first input coupled to an output of the flip-flop, a second input coupled to the clock input of the flip-flop, and an output forming the output of the latch.

The above description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim.

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

1. A method for signal amplification, comprising:
detecting an over-current condition associated with an amplifier;
adjusting an amplification gain to an adjusted gain level for an input signal based on the over-current condition, wherein the amplification gain is maintained at the adjusted gain level until occurrence of an amplifier gain event; and
amplifying, via the amplifier, the input signal based on the adjusted amplification gain.

2. The method of claim 1, further comprising receiving an amplifier gain event signal indicating the occurrence of the amplifier gain event.

3. The method of claim 2, wherein the amplifier gain event signal is a periodic signal.

4. The method of claim 1, wherein the amplifier gain event is associated with processing of a new packet for transmission.

5. The method of claim 1, wherein adjusting the amplification gain comprises adjusting a level of attenuation associated with an attenuator coupled to an input of the amplifier.

6. The method of claim 1, wherein adjusting the amplification gain comprises adjusting a bias current for the amplifier.

7. An apparatus for signal amplification, comprising:
an amplifier;
an over-current detection circuit coupled to the amplifier and configured to detect an over-current condition associated with the amplifier; and
a latch having an input coupled to an output of the over-current detection circuit and configured to adjust an amplification gain to an adjusted amplification gain level for an input signal based on the over-current condition, wherein the amplification gain is maintained at the adjusted amplification gain level until occurrence of an amplifier gain event, wherein the amplifier is configured to amplify the input signal based on the adjusted amplification gain level.

8. The apparatus of claim 7, further comprising a multiplexer configured to receive a first amplification gain code and a second amplification gain code, wherein an output of the latch is coupled to a select input of the multiplexer, and wherein an output of the multiplexer is coupled to:
a current digital-to-analog converter (IDAC) having an output coupled to a bias current input of the amplifier; or
a control input of an attenuator coupled to an input of the amplifier.

9. The apparatus of claim 7, wherein the latch is configured to receive an amplifier gain event signal indicating the occurrence of the amplifier gain event.

10. The apparatus of claim 9, wherein the amplifier gain event signal is a periodic signal.

11. The apparatus of claim 7, wherein the amplifier gain event is associated with processing of a new packet for transmission.

12. The apparatus of claim 7, further comprising an attenuator coupled to an input of the amplifier, wherein, to adjust the amplification gain, the latch is configured to adjust a level of attenuation associated with the attenuator.

13. The apparatus of claim 7, wherein, to adjust the amplification gain, the latch is configured to adjust a bias current for the amplifier.

14. An apparatus for signal amplification, comprising:
an amplifier;
a gain control circuit coupled to the amplifier;
an over-current detection circuit coupled to the amplifier; and
a latch having a first input coupled to an output of the over-current detection circuit and a second input configured to receive a control signal indicative of an amplifier gain event, the latch having an output coupled to the gain control circuit.

15. The apparatus of claim 14, wherein the gain control circuit comprises a multiplexer configured to receive a first amplification gain code and a second amplification gain code, wherein an output of the latch is coupled to a select input of the multiplexer, and wherein an output of the multiplexer is coupled to:
a current digital-to-analog converter (IDAC) having an output coupled to a bias current input of the amplifier; or
a control input of an attenuator coupled to an input of the amplifier.

16. The apparatus of claim 14, wherein the control signal is a periodic signal.

17. The apparatus of claim 14, wherein the amplifier gain event is associated with processing of a new packet for transmission.

18. The apparatus of claim 14, further comprising an attenuator coupled to an input of the amplifier, wherein the gain control circuit is configured to adjust a level of attenuation associated with the attenuator.

19. The apparatus of claim 14, wherein the gain control circuit is configured to adjust a bias current for the amplifier.

20. The apparatus of claim 14, wherein the latch comprises:
a flip-flop having a clock input forming the first input of the latch and a reset input forming the second input of the latch; and
an OR gate having a first input coupled to an output of the flip-flop, a second input coupled to the clock input of the flip-flop, and an output forming the output of the latch.
